(19) United States
(12) Patent Application Publication
(10) Pub. No.: US 2008/0132161 A1
(43) Pub. Date: Jun. 5, 2008

(54) METHOD FOR END-USER PROVISION OF INTERNET MULTIMEDIA SUBSYSTEM SERVICES

(76) Inventors: Simon Xu Chen, Qingdao (CN); Hans Peng Liu, Qingdao (CN)

Correspondence Address: MARK W. SINCELL;Williams, Morgan & Amerson, P.C., Suite 1100, 10333 Richmond, Houston, TX, 77042, US

(21) Appl. No.: 11/745,804

(22) Filed: May 8, 2007

(30) Foreign Application Priority Data
Dec. 1, 2006 (CN) 200610064475.2

(51) Int. Cl. H04H 1/00

(52) U.S. Cl. 455/3.05

(57) ABSTRACT

The present invention provides a method for providing multimedia services. The method includes receiving, at an application server, a request for at least one multimedia service from a first end-user device and determining whether said at least one multimedia service is provided by a second end user device. The method also includes providing a request for the at least one multimedia service to the second end user device in response to determining that the at least one multimedia service is provided by the second end-user device.

This patent application claims priority to the previously filed Chinese Application No. 200610064475.2 which was filed with the Chinese Patent Office on Dec. 1, 2006.

### BACKGROUND OF THE INVENTION

1. Field of the Invention

This invention relates generally to communication systems, and, more particularly, to wireless communication systems.

2. Description of the Related Art

Second generation wireless communication systems and networks are being replaced by wireless communication systems and networks that operate in accordance with third generation (3G) wireless communication standards, such as the wireless communication standards for UMTS defined by the Third Generation Partnership Project (3GPP) and the wireless communication standards for CDMA defined by the Third Generation Partnership Project-2 (3GPP2). For example, the 3GPP 33.203 and the 3GPP2 S.R0086 specifications define an Internet Protocol (IP) Multimedia Subsystem (IMS) that defines standards for using a signalling protocol called the Session Initiation Protocol (SIP). The SIP may be used to support various multimedia services that are provided to a mobile unit over an air interface. For example, an application server in the network may support one or more service applications that can be executed on the server to provide services to mobile units according the SIP. Exemplary IMS services include Internet conferencing, Internet telephony, video telephony, event notification, instant messaging, chat rooms, and the like.

FIG. 1 conceptually illustrates a conventional wireless communications system 100 that provides wireless connectivity according to a third generation wireless communication protocol such as the Code Division Multiple Access (CDMA) protocol defined in ANSI TIA/EIA/IS-2000 standard. The wireless communications system 100 shown in FIG. 1 may provide wireless connectivity to end users such as mobile units 105(1-3). In the interest of clarity, the indices (1-3) will hereinafter be dropped when the mobile units 105 are being referred to collectively. However, the indices (1-3) may be used when referring to the mobile units 105 individually or to a subset of the mobile units 105. The same convention will be used with regard to other indices that distinguish between components that share an identifying numeral. The mobile units 105 may be any type of mobile unit including, but not limited to, a cellular telephone 105(1), a personal data assistant 105(2), and a laptop computer 105(3).

The wireless communication system 100 includes a call session control function (CSCF) that operates according to the Internet Protocol (IP) Multimedia Subsystem (IMS) standards. The CSCF manages and controls IMS sessions in the core IMS network. Thus, in the illustrated embodiment, the first entry node of the CSCF is a proxy call session control function (P-CSCF) 120, which is responsible for forwarding SIP messages from the mobile units 105 to an interrogating CSCF (I-CSCF) 125 and/or a serving CSCF (S-CSCF) 130. The I-CSCF 125 is typically responsible for registration, routing, and forwarding of SIP messages of roaming mobile units 105. The S-CSCF 130 typically provides session control services that enable the network operator to support services that are provided to the mobile units 105. Exemplary functions of the S-CSCF 130 include management of mobile registrations, maintaining sessions, interaction with other services, charging, and security. The wireless communication system 100 also includes a Home Subscription Server (HSS) 135 that implements database functions that are required in next generation mobile networks, such as a Home Location Register (HLR), a Domain Name Server (DNS), and security and network access databases.

The mobile units 105 may establish one or more wireless communication links with the wireless communications system 100 over air interfaces 115(1-3). The air interfaces 115 may connect the mobile units 105 to the P-CSCF 125 as the entry node to the wireless communications system 100. The mobile units 105 may then utilize services provided by an application server (AS) 140 in the wireless communication system 100. For example, the mobile units 105 may provide requests for services over the air interfaces 115 and these requests may be forwarded to the application server 140 by the CSCF. In a conventional IMS service architecture, the application server 140 operates according to the SIP protocol and functions as the service creation and execution platform for the wireless communication system 100. The SIP application server 140 talks to the S-CSCF 130 for session control functions via a standard IMS service control (ISC) interface 145. The SIP application server 140 and the S-CSCF 130 also communicate with the home subscriber server 135 via the Sh interface 150 and the Cx interface 155, respectively, for various user registration functions. The SIP application server 140 may also have open application programming interfaces (APIs) for third party call controls.

The flexible framework and standard interfaces implemented in IMS networks has led to a boom in the creation of innovative new IP voice, data, and multimedia services. Network operators now have access to numerous new services that may be implemented in their networks and the demand for these services is increasing and is expected to continue to increase. However, adding new services to the network can incur substantial costs and consume significant network resources. For example, all the available services are typically stored and executed on the application server 140 of the IMS network 100, even if these services have relatively few subscribers, and service profiles for all authorized end users are loaded into the HSS 135. Moreover, different service applications are not easily blended together, so each new application requires its own dedicated resources and incurs its own deployment costs. Thus, the size, cost, and complexity of the application server 140 and/or the HSS 135 typically increase in proportion to the number of services that are provided and the number of authorized users.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for providing multimedia services. One embodiment of the method, which may be implemented at an application server, includes receiving, at an application server, a request for at least one multimedia service from a first end-user device and determining whether said at least one multimedia service is provided by a second end user device. The method also includes providing a request for the at least one multimedia service to the second end user device in response to determining that the at least one multimedia service is provided by the second end-user device.

In another embodiment of the present invention, a method is provided for providing multimedia services. One embodiment of the method, which may be implemented at an end-user device, includes providing, to an application server, a request for at least one multimedia service provided by an end-user device and receiving the at least one multimedia service provided by the end-user device in response to providing the request for said at least one multimedia service.

In yet another embodiment of the present invention, a method is provided for providing multimedia services. One embodiment of the method, which may be implemented at an end-user device, includes receiving, from an application server, a request for at least one multimedia service. The request is provided by an end-user device. The method may also include providing the at least one multimedia service to the end-user device in response to providing the request for the at least one multimedia service.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a conventional wireless communications system;

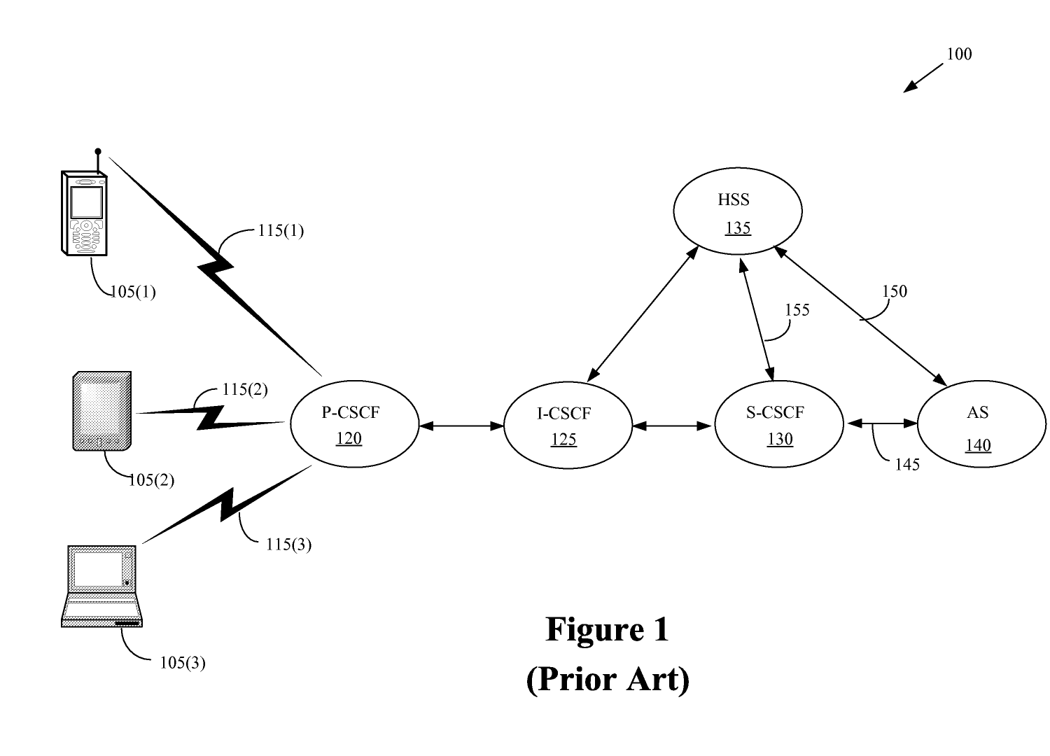

FIG. 2 conceptually illustrates one exemplary embodiment of a wireless communications system, in accordance with the present invention; and

FIG. 3 conceptually illustrates one exemplary embodiment of a method for registering and providing multimedia services using an end-user device, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and custom-ary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

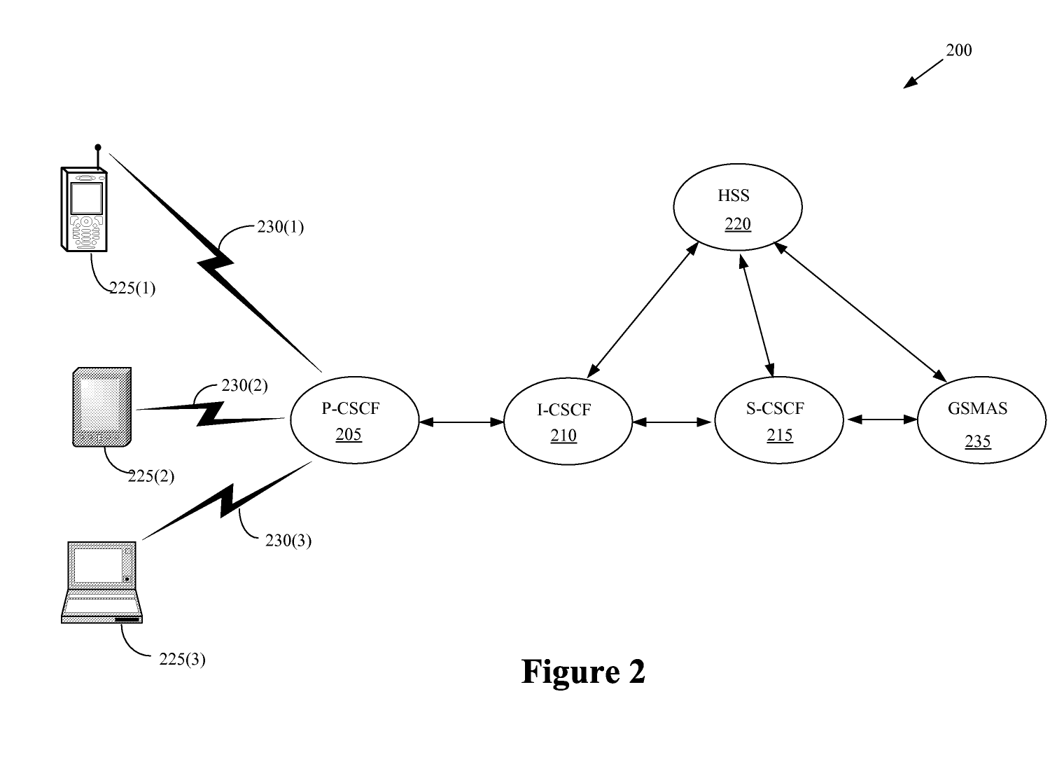

FIG. 2 conceptually illustrates one exemplary embodiment of a wireless communications system 200. In the illustrated embodiment, the wireless communications system 200 may provide wireless connectivity according to a third generation wireless communication protocol such as the Code Division Multiple Access (CDMA) protocol defined in ANSI TIA/EIA/IS-2000 standard. In the illustrated embodiment, the first entry node of the wireless communication system 200 is a proxy call session control function (P-CSCF) 205, which is communicatively coupled to an interrogating CSCF (I-CSCF) 210. The I-CSCF 210 may be communicatively coupled to a serving CSCF (S-CSCF) 215 and a Home Subscription Server (HSS) 220. The P-CSCF 205, I-CSCF 210, S-CSCF 215, and HSS 220, are known in the art and in the interest of clarity only those aspects of the operation of these elements that are relevant to the present invention will be described further herein. Furthermore, persons of ordinary skill in the art having benefit of the present disclosure should appreciate that, in alternative embodiments, the wireless communication system 200 may include more, fewer, and/or different elements than shown in FIG. 2. Although embodiments of the techniques described herein are discussed in the context of the wireless communication system 200, persons of ordinary skill in the art having benefit of the present disclosure should also appreciate that alternative embodiments of the present invention may also be implemented in systems that include wired networks.

The wireless communications system 200 shown in FIG. 2 may provide wireless connectivity to end-user devices such as one or more mobile units 225(1-3) using one or more wireless communication links over air interfaces 230(1-3). In the interest of clarity, the indices (1-3) may be dropped when the mobile units 225 and/or air interfaces 230 are being referred to collectively. However, the indices (1-3) may be used when referring to the mobile units 225 and/or air interfaces 230 individually or to a subset of the mobile units 225 and/or air interfaces 230. The same convention may be used with regard to other indices that distinguish between components that share an identifying numeral. The mobile units 225 may be any type of mobile unit 225 including, but not limited to, a cellular telephone 225(1), a personal data assistant 225(2), and a laptop computer 225(3). Other exemplary mobile units 225 may include smart phones, pagers, text messaging devices, Global Positioning System (GPS) devices, network interface cards, and desktop computers. Furthermore, persons of ordinary skill in the art having benefit of the present disclosure should appreciate that some embodiments of the wireless communication system 200 may also provide wired connectivity to end-user devices.

In the illustrated embodiment, mobile units 225 are configured to support multimedia services such as those defined according to the Session Initiation Protocol (SIP). For example, the mobile units 225 may implement the SIP User Equipment (UE) functionality that allows end-user devices to initiate and terminate SIP calls. The multimedia functionality may be implemented in hardware, firmware, software, or any combination thereof. For example, the SIP phone may be a hard phone or a software phone running in the mobile units 225. End-user devices such as the mobile units may provide keypad and/or other user interface (UI) views to enable users to view and/or input information. For example, most hard phones come with large LCD displays for output information. The SIP UE in the mobile units (or other end-user devices) is enhanced to incorporate end user application server functionality that permits the end-user device to implement and execute one or more services that may be provided to other end-user devices via proxy call session control functions associated with the end-user devices. The mobile units 225 (or other end-user devices) may therefore support both the reception of IP multimedia services and provision of IP multimedia services to other end users. The multimedia services that may be provided and/or received by the end-user devices and/or a server may be referred to herein as “generic services” to distinguish these services from conventional multimedia services that are only provided by a central server, as discussed above.

The mobile units 225 may use messages including modified headers to signal support for reception and/or provision of IP multimedia services. The headers may also be used to register multimedia services that are provided by the mobile units 225. In one embodiment, the messages include a private header extension P-Generic-Service header that may be introduced into the SIP signaling for generic service creation and invocation. For example, the private header may be defined as:

```
P-Generic-Service = “P-Generic-Service” HCOLON
      P-Generic-Service-Operation COMMA
      P-Generic-Application
      * (COMMA P-Generic-Application)
P-Generic-Service-Operation = “register” / “query” /
“notify” / “invoke” / token
P-Generic-Application = “P-Generic-Application”
HCOLON
      P-Generic-Service-ID COMMA
      P-Generic-Service-Description
    * (COMMA P-Generic-Service-ID COMMA
      P-Generic-Service-Description)
P-Generic-Service-ID = 1*DIGIT
P-Generic-Service-Description = “multilingual-
interpretation” EQUAL quoted-string
```

The private header may be embedded in various messages, such as those defined by the SIP protocols. For example, the private header may be embedded in SIP REGISTER messages that are used to register SIP sessions and/or 2000K response messages that are transmitted by the mobile units 225 to indicate success of a previous request. The private header may also be embedded in SIP INVITE messages sent by the mobile units 225 to initiate actions in the SIP session. However, persons of ordinary skill in the art having benefit of the present disclosure should appreciate that alternative definitions of the headers, as well as other techniques for signaling service creation and/or invocation, may be used.

The mobile units 225 may be configured to support IP multimedia services based upon user input. In one embodiment, the mobile units 225 include functionality that allows a user to turn support for IP multimedia services on or off. For example, the mobile unit 225 may include a switch button and/or an icon that is displayed on an LCD panel that allows the user to turn on or off the generic service support. A user interface (UI) in the mobile units 225 may allow users to view information indicating the service operation types, an identifier of the service, a service description, or any other information. The user interface may also be used to compose the P-Generic-Service header for service registration that may be sent in a REGISTER message. Messages received from the wireless communication system 200, such as a P-Generic-Service header that includes a query to discover the services provided by the mobile unit 225 may be parsed by the mobile units 225 and displayed to the user. In one embodiment, multiple results may be displayed and the user can scroll down and up to locate the right entry. The user interface may also be used to compose the P-Generic-Service header for service invocation, which may be transmitted in an INVITE message defined by the SIP protocol. The user interface may also provide operations like “Dial”, “Edit” and “Save” on the phone terminal.

The wireless communication system 200 includes a generic service manager application server (GSMAS) 235. In the illustrated embodiment, the application server 235 receives registration information from mobile units 225 and manages the registered mobile units 225. The application server 235 may also provides services such as call forwarding and call waiting to the end-user devices. In one embodiment, the generic service manager application server 235 may be located in the IMS service plane and manage the registration and query of specific services, as well as the invocation of service logics that may be provided by one end-user to other end-user. For example, the application server 235 may be configured to recognizes and parse the P-Generic-Service header embedded in the REGISTER and INVITE messages sent by the mobile units 225, and thereby detect messages requesting registration, query, and/or invocation of IP multimedia services provided by one or more of the mobile units 225, as well as provided by the application server 235. The application server 235 may also associate identifiers with the services provided by the mobile units 225 and support storage and retrieval of the identifying information into/from a database maintained by the application server 235.

The application server 235 may also form and/or transmit messages including modified headers to signal responses to service queries and/or provision of requested IP multimedia services. In one embodiment, the messages include a private header extension P-Generic-Service header that may be introduced into the SIP signaling for generic service creation and invocation. For example, the application server 235 may compose a P-Generic-Service header that includes information indicating the results of a service query and incorporate the P-Generic Service header in a 200 OK response message that may be sent to a SIP phone. The application server 235 may also support execution of service logics to deliver the service request to an end user to generic service ID in INVITE message from the S-CSCF 215.

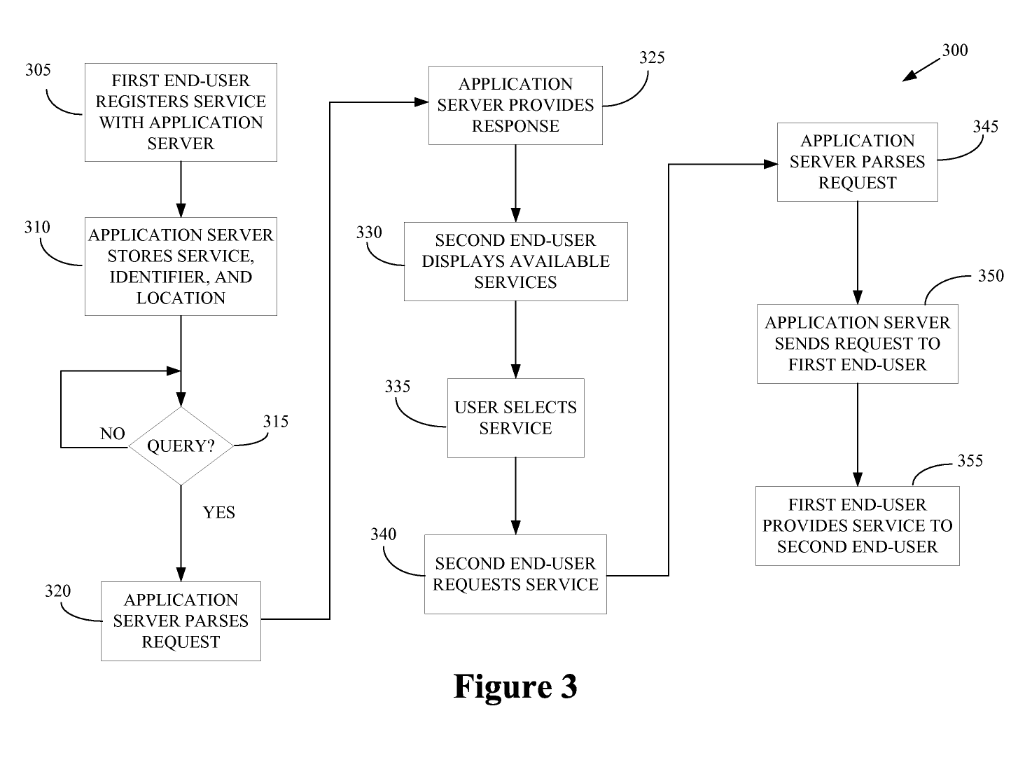

FIG. 3 conceptually illustrates one exemplary embodiment of a method 300 for registering and providing multimedia services using an end-user device. In the illustrated embodiment, a first end-user device registers (at 305) an IP multimedia service with an application server. For example, an end user who wants to provide a generic service registers (at 305) that generic service via the SIP phone terminal in the end-user device by inputting a generic service ID that identifies the IP multimedia service that will be provided by the first end-user device. The user also may indicate a “register” operation type through the phone keypad. The end-user device composes a P-Generic-Service header that may be incorporated in a REGISTER message and sends the REGISTER message to a generic service manager application server. The generic service manager application server parses the registration request and stores (at 310) information indicating the provided service, the generic service ID, and a contact address associated with the end-user device into a database.

A second end-user device may request information indicating the services that may be provided by the first end-user device, as well as other end-user devices and/or the application server. For example, an end user who wants to know what services are supported may query the generic service ID list by inputting the query operation type via the SIP phone in the end-user device. The phone composes the P-Generic-Service header in REGISTER message and sends to generic service manager application server. As long the generic service manager application server does not detect (at 315) a query for information indicating the provided services, the generic service manager application server may wait to receive a query. When the generic service manager application server detects (at 315) a query from a second end-user device, the generic service manager application server may parse (at 320) the message including the request. The generic service manager AS may then retrieve one or more generic service IDs stored in the database based on the results of parsing (at 320) the request message from the second end-user device.

The generic service manager application server may provide (at 325) a response to the second end-user device based upon the retrieved results. In one embodiment, the generic service manager application server may provide (at 325) a message indicating the services that are supported by the first end-user device, other end-user devices, and/or the generic service manager application server. For example, the generic service manager application server may compose (at 325) a P-Generic-Service header to include the list of all supported generic service IDs and embed the header in a 200 OK response message, which the generic service manager application server sends to the SIP phone in the end-user device.

The second end-user device may then display (at 330) the results of the query to the end-user. In one embodiment, the SIP phone in the end-user device may receive a 200 OK response message from the generic service manager application server and may parse the P-Generic-Service header to determine the available services, the associated service identifiers, and short descriptions of the services. The second end-user device may then display (at 330) the generic service IDs of the available services and the short descriptions for end users. For example, a second end-user device may display (at 330) a list of the generic service identifiers and the short descriptions on a touch sensitive screen in the second end-user device. The end-user may select (at 335) one of the display services, e.g., using the touch-sensitive screen.

The second end-user device requests (at 340) the service in response to the user selecting (at 335) the service. In one embodiment, the user or the end-user device initiates a call to the wireless communication system in response to the user selecting (at 335) one of the services. The SIP phone in the end-user device sends an INVITE message to the CSCF carrying a P-Generic-Service header that includes the generic service ID of the selected to service and an “invoke” operation type that indicates that the second end-user device would like to invoke the selected service. The CSCF detects P-Generic-Service header in INVITE message and proxies the INVITE message to generic service manager application server. The generic service manager application server parses (at 345) the invocation request and applies the service logic to deliver (at 350) the service request to the first end-user based on the generic service ID received in the request to invoke the selected service. The first end-user device may then provide (at 355) the selected service to the second end-user.

Embodiments of the techniques described herein may permit network operators to utilize resources provided by end-user devices, which are becoming more and more powerful with each successive generation. For example, many end user devices include processing power and memory capacities sufficient to provide many IP services. Thus, embodiments of the techniques described herein may allow end users to act as 3^{rd} party service providers or content providers by providing relatively small but valuable applications like simultaneous interpretation, trash chat, free parking search, rental service and health care consultation, etc. The services supported by end-user devices, which are referred to herein as generic services, may be provided to other end-user devices in self-help mode the service creation and invoking mechanism described herein. Operators of the end-user devices can define and announce the generic service ID that is used to identify each type of applications. For example, the generic service ID 1100 may represent simultaneous interpretation service and the generic service ID 1101 may represent health care consultation.

Operators may also deploy a generic service manager application server in their network to manage the registration and invoking of generic services. The end-user devices that can provide one or more services can register a generic service ID and its contact address to this generic service manager application server through the CSCF. Once the end-user device has registered one or more services, this device becomes an end user application server for the registered service ID type. Other end user devices that want to use the registered service can embed the generic service ID in call attempt SIP signaling messages. The generic service manager application may then detect the generic service ID and deliver the service request to an end user application server. Thus, every end user device may act as an application server that provides services, while at the same time enjoying the services provided by other end user application servers and the application server in the operator's network. These techniques may therefore reduce the workload of application servers in the operator's network and increase the number and diversity of services that are provided to end-user devices in the network.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

What is claimed:

1. A method of providing multimedia services, comprising:
receiving, at an application server, a request for at least one multimedia service from a first end-user device;
determining whether said at least one multimedia service is provided by a second end user device; and
providing a request for said at least one multimedia service to the second end user device in response to determining that said at least one multimedia service is provided by the second end-user device.

2. The method of claim 1, wherein receiving the request for said at least one multimedia service comprises receiving at least one message including a header indicative of the request for said at least one multimedia service.

3. The method of claim 1, wherein determining whether said at least one multimedia services provided by a second end-user device comprises accessing a database including information indicative of said at least one multimedia service and at least one second end-user device that provides said at least one multimedia service.

4. The method of claim 1, wherein providing a request for said at least one multimedia service to the second end-user device comprises providing at least one message including a header indicative of the request for said at least one multimedia service.

5. The method of claim 1, comprising receiving, from the second end-user device, a request to register said at least one multimedia service.

6. The method of claim 5, comprising associating an identifier with the second end-user device and storing information indicative of the identifier and said at least one multimedia service in a database.

7. The method of claim 1, comprising receiving, from the first end-user device, a request for information indicative of available multimedia services and providing, in response to this request, the information indicative of at least one available multimedia service.

8. A method of providing multimedia services, comprising:
providing, to an application server, a request for at least one multimedia service provided by an end-user device; and
receiving said at least one multimedia service provided by the end-user device in response to providing the request for said at least one multimedia service.

9. The method of claim 8, wherein providing the request for said at least one multimedia service comprises providing at least one message including a header indicative of the request for said at least one multimedia service.

10. The method of claim 8, comprising providing a request for information indicative of available multimedia services.

11. The method of claim 10, comprising receiving, in response to the request for information indicative of available multimedia services, information indicative of at least one available multimedia service from the application server.

12. The method of claim 11, comprising displaying information indicative of at least one available multimedia service to a user.

13. The method of claim 12, wherein providing the request for at least one multimedia service comprises providing a request for said at least one multimedia service based on input provided by the user.

14. A method of providing multimedia services, comprising:
receiving, from an application server, a request for at least one multimedia service, the request being provided by an end-user device; and
providing said at least one multimedia service to the end-user device in response to providing the request for said at least one multimedia service.

15. The method of claim 14, wherein receiving the request for said at least one multimedia service comprises receiving at least one message including a header indicative of the request for said at least one multimedia service.

16. The method of claim 14, comprising providing, to the application server, a request to register said at least one multimedia service.

17. The method of claim 16, wherein providing the request to register said at least one multimedia service comprises providing at least one message including a header indicative of the request to register said at least one multimedia service.

18. The method of claim 16, wherein providing the request to register said at least one multimedia service comprises providing the request and response to user input that indicates support for providing said at least one multimedia service to the end-user device.
